(19) United States
(12) Patent Application Publication
(10) Pub. No.: US 2023/0329221 A1
(43) Pub. Date: Oct. 19, 2023

(54) CONTROLLING PLANTS BY MEANS OF ELECTRICAL ENERGY

(71) Applicant: Bayer Aktiengesellschaft, Leverkusen (DE)

(72) Inventors: Christoph BREITENSTROETER, Basel (CH); Sergio JIMENEZ TARODO, Düsseldorf (DE); James HADLOW, Newmarket (GB)

(73) Assignee: Bayer Aktiengesellschaft, Leverkusen (DE)

(21) Appl. No.: 17/289,641

(22) PCT Filed: Oct. 28, 2019
(86) PCT No.: PCT/EP2019/079374

§ 371 Date: Feb. 14, 2022

(30) Foreign Application Priority Data
Nov. 2, 2018 (EP) 18204105.3

(51) Int. Cl. A01M 21/04

(52) U.S. Cl. CPC A01M 21/046

(57) ABSTRACT

The present disclosure relates to the control of plants which appear as undesirable matter in a field for crop plants by means of electrical energy. The subject matter of the present disclosure is a method, a device and a vehicle for controlling plants

### CROSS REFERENCE TO RELATED APPLICATIONS

This application is a national stage application under 35 U.S.C. § 371 of International Application No. PCT/EP2019/079374, filed internationally on Oct. 28, 2019, which claims priority benefit of European Application No. 18204105.3, filed Nov. 2, 2018.

### FIELD OF THE DISCLOSURE

The present disclosure deals with controlling plants by means of electrical energy, which plants appear as undesired cohabitants in a field for cultivated plants. Subjects of the present disclosure are a method, a device and a vehicle for controlling the plants.

### BACKGROUND OF THE INVENTION

When cultivated plants are cultivated in a field, undesired accompanying plants usually appear, which compete with the cultivated plants for resources, hinder the implementation of agricultural measures or make said implementation more difficult, impair the quality of the harvest or adversely affect the cultivation of the cultivated plants in some other way. These cultivated-plant cohabitants can be, for example, weeds/grass weeds or plants which were cultivated in the field in a previous vegetation period and are now sprouting.

A number of measures are generally available for controlling undesired plants, such as, for example, application of a herbicide, mechanical removal or control by means of electrical energy.

Application of a herbicide is only practical if the cultivated-plant cohabitant can be selectively controlled without the surrounding cultivated plants suffering damage. Mechanical removal is comparatively arduous and/or cost-intensive.

Controlling plants by means of electrical energy has been known for decades and has been extensively described in the prior art (see, for example, US248443, U.S. Pat. Nos. 2,591,597, 2,682,729, 4,047,326, 4,428,150, WO16016627, WO16162667, WO2018050137, WO2018050138, WO2018050142, WO2018050143, WO2018095450, WO2018095451).

Controlling cultivated-plant cohabitants in a field of cultivated plants by means of electrical energy has also been described in the prior art. M. F. Diprose et al. report on the control of bolters in a sugar beet field (Use of electricity to control bolters in sugar beet (Beta vulgaris L.): a comparison of the electrothermal with chemical and mechanical cutting methods, Weed Research 1985, Vol. 25, pages 53-60). Contact electrodes were moved over the field at a distance of about 5-15 cm above the sugar beets and contacted the larger bolters in the process. Upon contact, a current flowed through the bolters and rendered them harmless; the smaller sugar beets were spared. The approach described only makes it possible to control cultivated-plant cohabitants that are larger than the surrounding cultivated plants.

### SUMMARY OF THE DISCLOSURE

Proceeding from the prior art described, a person skilled in the art is faced with the objective technical object of providing means which make it possible to control cultivated-plant cohabitants that are smaller than the surrounding cultivated plants without damaging the surrounding cultivated plants.

According to some embodiments, the present invention therefore provides in a first aspect a method for controlling cultivated-plant cohabitants in a field of cultivated plants,
providing a device comprising a crop divider and a contact electrode,
bringing the crop divider to a height which is above the growth height of the cultivated-plant cohabitants and below the growth height of the cultivated plants,
bringing the contact electrode to a height which is below the crop divider at the growth height of the cultivated-plant cohabitants,
moving the device through a field for cultivated plants, in which cultivated-plant cohabitants appear,
during the movement
guiding the cultivated plants past the contact electrode by means of the crop divider,
contacting the cultivated-plant cohabitants with the contact electrode, wherein contact of the contact electrode with a cultivated-plant cohabitant leads to flow of a current from the contact electrode through part of the cultivated-plant cohabitant to a counter electrode, whereupon the cultivated-plant cohabitant is weakened or destroyed.

According to some embodiments, the present invention further provides a device for controlling cultivated-plant cohabitants in a field of cultivated plants, comprising
a crop divider comprising two lateral sides, wherein the lateral sides converge at a tip,
a contact electrode, wherein the contact electrode
is situated below the crop divider and
is situated on a side of the crop divider that is opposite the tip of the crop divider,
fastening means for fastening the crop divider to a vehicle at a height which is above the growth height of the cultivated-plant cohabitants and below the growth height of the cultivated plants.

According to some embodiments, the present invention further provides a vehicle for controlling cultivated-plant cohabitants in a field of cultivated plants, comprising
a crop divider comprising two lateral sides, wherein the lateral sides converge at a tip,
a contact electrode,
a voltage source and
a counter electrode,
   characterized in that the crop divider is adjustable in height and the contact electrode is situated below the crop divider and is situated on a side of the crop divider that is opposite the tip of the crop divider.

According to some embodiments, the present invention further provides for the use of the vehicle according to the invention and/or the device according to the invention for controlling plant cohabitants in a field of cultivated plants, wherein the plant cohabitants have a lower growth height than the cultivated plants.

The invention will be more particularly elucidated below without distinguishing between the subjects of the invention (method, device, vehicle, use). Instead, the elucidations that follow are intended to apply analogously to all the subjects of the invention, irrespective of the context (method, device, vehicle, use) in which they occur.

If steps are stated in an order in the present description or in the claims, this does not necessarily mean that the invention is restricted to the stated order. Instead, it is conceivable that the steps can also be executed in a different order or else in parallel to one another, unless one step builds upon another step, which necessarily means that the step building upon the other is executed subsequently (but this will be clear in the individual case). The orders stated are thus preferred embodiments of the invention.

The term “field” is understood to mean a spatially delimitable region of the surface of the earth under agricultural cultivation, in that such a field is planted with cultivated plants that are supplied with nutrients and harvested.

The term “cultivated plant” is understood to mean a plant which is specifically grown as a useful plant or ornamental plant by human intervention.

The term “cultivated-plant cohabitant” is understood to mean a plant which grows between the cultivated plants which are being cultivated, but, in contrast to the cultivated plants, has not been specifically cultivated to achieve a harvest yield or some other purpose in the current vegetation period. A cultivated-plant cohabitant can be weeds, grass weeds, feral cultivated plants, volunteer plants or the like. Cultivated-plant cohabitants in the context of the present invention are accordingly plants which appear as undesired company when a desired cultivated plant is cultivated. They can affect the quality and/or quantity of the harvest by competing with the cultivated plant for resources, making the implementation of agricultural measures more difficult and contaminating the cultivated plants that are harvested. Cultivated-plant cohabitants should therefore be controlled.

The term “control” is understood to mean preventing the spread of or reducing the amount of cultivated-plant cohabitants that are present.

Control is achieved using a device which is moved through the field in which the cultivated plants are being cultivated. For this purpose, the device has fastening means with which the device can be fastened to a vehicle. The vehicle can be a motor-driven vehicle which moves through the field on wheels, rails or chains, such as, for example, an agricultural machine, a tractor, a Unimog or the like. The vehicle preferably moves through the field in an autonomous manner, i.e., without human assistance.

During the movement, the device selectively controls cultivated-plant cohabitants, whereas cultivated plants are disregarded.

This is done by separating the cultivated-plant cohabitants from the surrounding cultivated plants by means of a crop divider.

Crop dividers have been widely described in the prior art (see, for example, GB151624A, GB175015A, DE513153 (C), AT122999 B, U.S. Pat. Nos. 2,209,047A, 2,365,790A, GB567950A, US2016057933, WO15159464A1). Their task usually consists in separating one part of cultivated plants from a population of cultivated plants in order to process (e.g., to harvest) said part. According to some embodiments, such a crop divider is attached to the device according to the invention. It is situated in front of the contact electrode in the direction of movement of the device according to the invention. The crop divider is furthermore mounted at a height which is below the upper ends of the cultivated plants and above the upper ends of the cultivated-plant cohabitants.

It is also conceivable that the device according to the invention comprises multiple crop dividers. These are preferably arranged next to one another and spaced apart from one another such that they preferably extend perpendicularly to gravity and transversely to the direction of movement.

“Transversely to the direction of movement” refers to a direction which extends at an angle of at least 30° and at most 150°, preferably at least 45° and at most 135° and even more preferably at least 60° and at most 120° to the direction of movement. The direction of movement and the direction “transversely to the direction of movement” preferably span a plane which runs tangentially to the surface of the earth.

A crop divider can be designed such that it tapers toward the front (in the direction of movement of the device according to the invention).

When the crop divider moves through the field, the cultivated plants are moved to the side by the crop divider and guided backward along the crop divider. Behind the crop divider, the cultivated plants move back to their initial positions.

Attached to the rear end of the crop divider is a contact electrode, preferably transversely to the direction of movement of the device.

The crop divider guides the cultivated plants past the contact electrode. By contrast, owing to their lower growth height, the cultivated-plant cohabitants are not swept away by the crop divider and are not guided to the sides of the crop divider and are not guided past the contact electrode. Instead, the crop divider moves over the cultivated-plant cohabitants.

The contact electrode is arranged at a height at which it contacts parts of the cultivated-plant cohabitants when the crop divider moves over the cultivated-plant cohabitants. The contact electrode is thus situated at the growth height of the cultivated-plant cohabitants. Contact of the contact electrode leads to flow of an electric current through part of the cultivated-plant cohabitant, and the cultivated-plant cohabitant is rendered harmless by the electric current.

The crop divider and the contact electrode are preferably variable in height, so that they can be adjusted to the growth height of the cultivated plants and cultivated-plant cohabitants. It is conceivable that the crop divider and contact electrode are adjusted in height independently of one another; however, it is also conceivable that the contact electrode is connected to the crop divider and that the contact electrode and the crop divider are adjusted in height at the same time.

According to some embodiments, the vehicle according to the invention preferably has a height-adjustment unit with which the height of the crop divider and/or the contact electrode can be varied. The term “height” is understood to mean the distance between the lower edge of the crop divider or the contact electrode and the ground. The term “lower edge” refers to the part of the crop divider or the contact electrode that has the shortest distance from the ground.

Height adjustment is preferably done automatically. It is, for example, conceivable that the device or the vehicle has one or more cameras which are used to ascertain the height at which the cultivated plants and/or the cultivated-plant cohabitants end (growth height). It is also possible to ascertain plant growth height using one or more distance sensors. Distance sensors are commercially available in various forms and are based on different measurement principles such as radar (W. Paul, H. Speckmann: Radarsensoren-Neue Technologien zur prüzisen Bestandsführung [Radar sensors-new technologies for precise crop management], Landtechnik 59, 2/2004, pages 92 to 93), laser light (https://www.researchgate.net/publication/265943938) or ultrasound (D. Nieberg et al.: Multireflex-Ultraschall-Sensorsystem zur Feld-Phanotypisierung von Getreide [Multireflection ultrasonic sensor system for phenotyping of crops in fields], https://www.hs-osnabrueck.de/fileadmin/HS OS/Homep ages/COALA/Veroeffentlichungen/2014-VDI-Tagung-Multireflex-Ultraschall-S ensorsystem_zur_Feld-Phaenotypi sierung_von_Getreide_.pdf).

The contact electrode can be designed as a cantilever, mesh, grid, strip, brush or the like. Multiple contact electrodes can also be present instead of one contact electrode.

The counter electrode can also be designed as a cantilever, mesh, grid, strip, brush or the like. It is likewise conceivable that multiple counter electrodes are present.

Cultivated-plant cohabitants are controlled by application of a voltage between the contact electrode and the counter electrode.

The voltage is generated by means of a voltage source, which is usually a component of the device according to the invention or the vehicle according to the invention. However, it is in principle also conceivable that the voltage source is set up in a fixed position in the field and is connected to the contact electrode and the counter electrode via a cable connection. The voltage source can be a generator or an accumulator.

A current usually only flows between the contact electrode and the counter electrode if the electrical resistance between the contact electrode and the counter electrode is reduced, for example as a result of parts of a plant being brought between the contact electrode and the counter electrode, which parts have a lower resistance than the surrounding air. The current then flows through said parts of the plants, either from the contact electrode to the counter electrode or from the counter electrode to the contact electrode depending on the (current) polarity. In the case of use of an alternating voltage, the current flows from the contact electrode through the plant parts to the counter electrode and from the counter electrode through the plant parts to the contact electrode in an alternating manner. Suitable parameters (current intensity, voltage, frequency) for controlling cultivated-plant cohabitants can be gathered from the prior art (see, for example, US248443, U.S. Pat. Nos. 2,591,597, 2,682,729, 4,047,326, 4,428,150, WO16016627, WO16162667, WO2018050137, WO2018050138, WO2018050142, WO2018050143, WO2018095450, WO2018095451, M. F. Diprose et al., Weed Research, 1985, 25, 53-60).

When controlling plants by means of electrical energy, it is customary not to bring the counter electrode directly into contact with the plant to be controlled, but rather to bring the counter electrode into contact with the ground in which the plant is growing, since the current also flows through the roots of the plant as a result and the roots are hence also damaged, which is a particularly effective way of controlling the plant.

According to some embodiments, in the case of the present invention as well, the counter electrode is preferably in contact with the ground.

According to some embodiments, the counter electrode can be a component of the device according to the invention or it can be a component of the vehicle according to the invention to which the device according to the invention can be fastened; however, it can also be an object independent of the device and the vehicle. In a preferred embodiment, the counter electrode is a component of the vehicle and is in contact with the ground or can be contacted with the ground. It is conceivable that the counter electrode is designed as a sliding contact which slides on the soil when the device is moving through the field. It is also conceivable that one or more wheels of the vehicle or of the device are designed as a counter electrode.

It is conceivable that there is a permanent voltage between the contact electrode and the counter electrode. Once the contact electrode comes into contact with a plant, a current flows between the contact electrode and the counter electrode through the plant. However, it is also conceivable that the contact electrode and counter electrode are kept voltage-free and a voltage is applied between the contact electrode and the counter electrode only when a cultivated-plant cohabitant nears the contact electrode. This can be achieved by means of distance sensors or light barriers. It is, for example, conceivable that the lateral sides of the crop divider have guiding flanks attached thereto, between which a light barrier is provided in front of the contact electrode. The guiding flanks support the guiding of cultivated plants past the contact electrode. Relatively small cultivated-plant cohabitants are not swept away by the guiding flanks and get between the guiding flanks below the crop divider. They interrupt the light barrier, thereby establishing a voltage between the contact electrode and the counter electrode. It is furthermore conceivable to use contact sensors which enable the voltage between the contact electrode and the counter electrode only when the contact electrode comes into contact with a cultivated-plant cohabitant.

According to some embodiments, the device according to the invention can be designed such that, in addition to cultivated-plant cohabitants having a lower growth height than the surrounding cultivated plants (“relatively small cultivated-plant cohabitants”), it can also control cultivated-plant cohabitants having a greater growth height than the surrounding cultivated plants (“relatively large cultivated-plant cohabitants”). It is conceivable that, in a first operational step, the contact electrode is brought to a height which is brought above the growth height of the cultivated plants and below the growth height of the relatively large cultivated-plant cohabitants. The crop divider is situated above the contact electrode and hence above the cultivated plants, but also above the relatively large cultivated-plant cohabitants (it thus does not perform any function at this height). The contact electrode is moved through the field and only contacts the relatively large cultivated-plant cohabitants and renders them harmless. In a second operational step, the crop divider and the contact electrode are lowered to a height at which the crop divider is situated below the growth height of the cultivated plants and above the growth height of the relatively small cultivated-plant cohabitants, so that it can guide the cultivated plants past the contact electrode. The contact electrode is mounted below the crop divider, so that it comes into contact with the relatively small cultivated-plant cohabitants as the contact electrode moves through the field. Thus, in the second operational step, the relatively small cultivated-plant cohabitants are then rendered harmless.

In a preferred embodiment, the length of the contact electrode is variable. “Length” is understood to mean the extent of the contact electrode in the direction of gravity. “Width” refers to the extent of the contact electrode perpendicular to gravity and transverse (preferably perpendicular) to the direction of movement. “Thickness” refers to the extent of the contact electrode in the direction of movement. It is, for example, conceivable that the contact electrode comprises one or more metal strips which are, for example, rolled up on a reel. The length of the metal strips can be varied by unwinding from the reel or winding onto the reel. It is also conceivable that part of the contact electrode can be positioned behind the crop divider and can be extended downward (in the direction of gravity) if a longer contact electrode is required. A contact electrode designed to be variable in length has the advantage that it can be optimally adjusted to the growth height of the cultivated-plant cohabitants and to the difference in the growth height between the cultivated plants and cultivated-plant cohabitants.

The contact electrode can (also) be designed to be variable in its width especially if the device according to the invention is oriented for controlling both relatively small and relatively large cultivated-plant cohabitants. If the contact electrode is used for controlling relatively small cultivated-plant cohabitants, it should not protrude beyond the side edges of the crop divider, since the cultivated plants may otherwise come into contact with the contact electrode. If the contact electrode is used for controlling relatively large cultivated-plant cohabitants, the contact electrode can protrude beyond the side edges of the crop divider, since cultivated plants do not come up to the contact electrode owing to the lower growth height. A contact electrode protruding beyond the side edges of the crop divider has the advantage that it covers a larger area during movement through the field and hence catches a larger number of relatively large cultivated-plant cohabitants and renders them harmless. In a preferred embodiment, the contact electrode is therefore designed such that its extent can be varied transversely to the direction of movement (width). It is, for example, conceivable to provide a foldable contact electrode which does not protrude beyond the side edges of the crop divider when folded up, but protrudes beyond the side edges of the crop divider when folded out.

### BRIEF DESCRIPTION OF THE DRAWINGS

The invention is described in detail below with reference to figures, without wishing to restrict the invention to the features and combinations of features that are shown in the figures.

In the figures:

FIG. 1 shows schematically (a) a frontal view, (b) a first side view, (c) the underside, (d) a second side view, (e) a rear view and (f) a top view of one embodiment of a crop divider.

FIG. 2 shows schematically (a) a frontal view, (b) a first side view, (c) the underside, (d) a second side view, (e) a rear view and (f) a top view of the crop divider (10) from FIG. 1 together with a contact electrode.

FIG. 3 shows schematically (a) a frontal view, (b) a first side view, (c) the underside, (d) a second side view, (e) a rear view and (f) a top view of the crop divider (10) from FIG. 1 together with a contact electrode.

FIG. 4 shows schematically the crop divider (10) with the contact electrode (20) from FIG. 3.

FIG. 5 shows schematically the crop divider (10) with the contact electrode (20) from FIG. 2.

FIG. 6 shows schematically (a) a frontal view, (b) a first side view, (c) the underside, (d) a second side view, (e) a rear view and (f) a top view of the crop divider (10) from FIG. 1 together with a contact electrode.

FIG. 7 shows schematically (a) a side view and (b) a frontal view of a vehicle according to the invention.

FIG. 8 (a)-(b) shows schematically the use of a crop divider together with a contact electrode in controlling a cultivated-plant cohabitant in a population of cultivated plants.

### DETAILED DESCRIPTION OF EXEMPLARY EMBODIMENTS

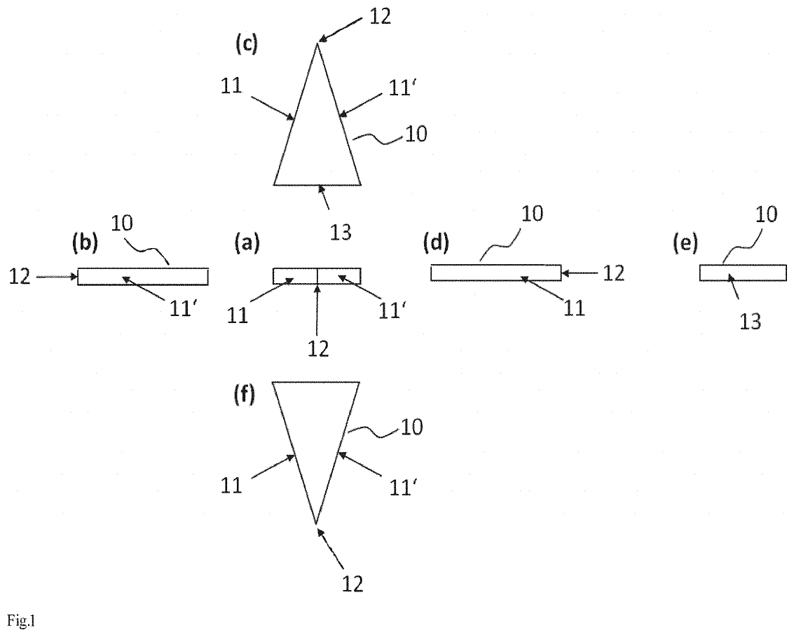

FIG. 1 shows schematically (a) a frontal view, (b) a first side view, (c) the underside, (d) a second side view, (e) a rear view and (f) a top view of one embodiment of a crop divider.

The crop divider (10) comprises two lateral sides (11, 11′) which converge at a tip (12). The base (13) is situated on the side opposite the tip.

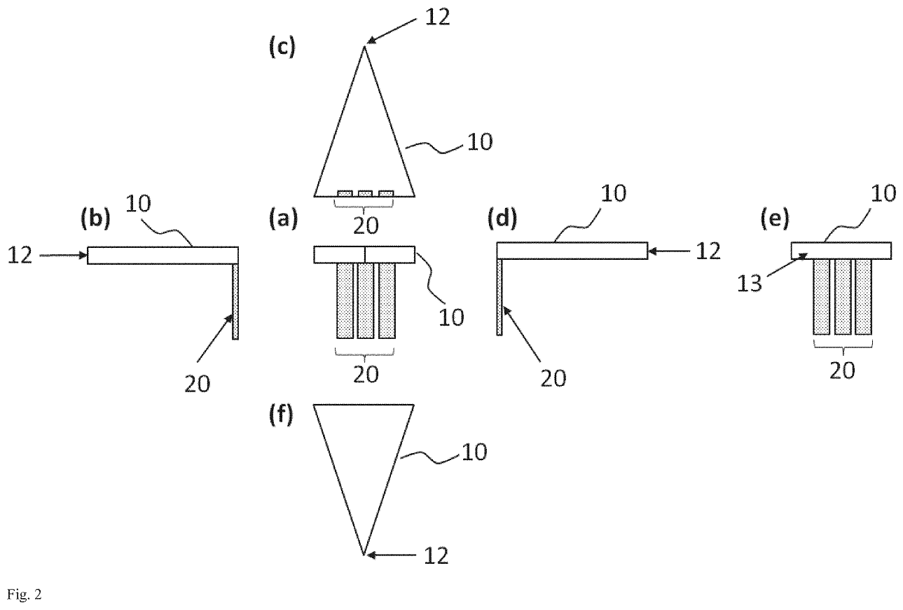

FIG. 2 shows schematically (a) a frontal view, (b) a first side view, (c) the underside, (d) a second side view, (e) a rear view and (f) a top view of the crop divider (10) from FIG. 1 together with a contact electrode.

The contact electrode (20) is situated below the crop divider (10). The contact electrode (20) is furthermore situated on a side (base 13) opposite the tip (12) of the crop divider (10). The contact electrode (20) can be fastened to the crop divider. The contact electrode (20) comprises three flexible metal strips.

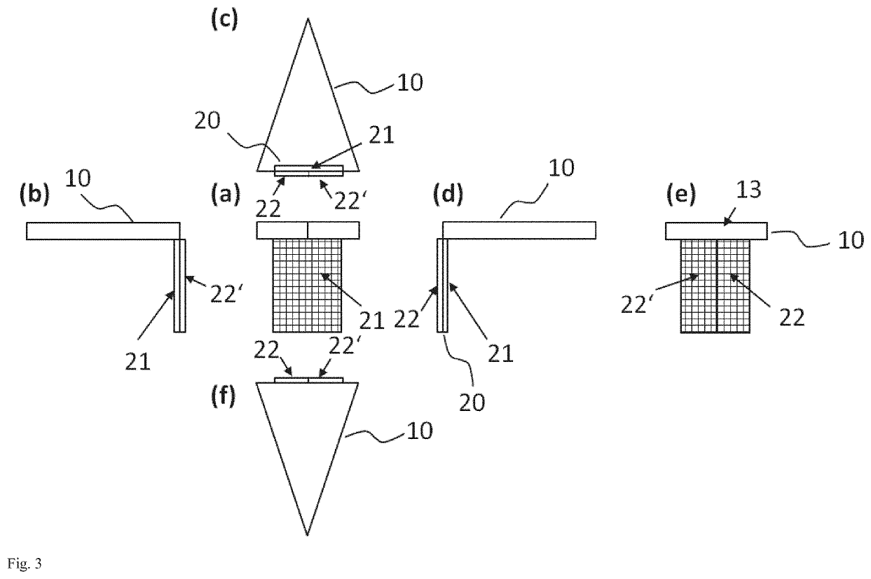

FIG. 3 shows schematically (a) a frontal view, (b) a first side view, (c) the underside, (d) a second side view, (e) a rear view and (f) a top view of the crop divider (10) from FIG. 1 together with a contact electrode.

The contact electrode (20) is situated below the crop divider (10). The contact electrode (20) is furthermore situated on a side (base 13) opposite the tip (12) of the crop divider (10). The contact electrode (20) can be fastened to the crop divider. The contact electrode (20) is designed as a grid or matting; it comprises three parts, a base part (21) and two side parts (22, 22′). The side parts (22, 22′) are outwardly foldable; in FIG. 3, they are folded in.

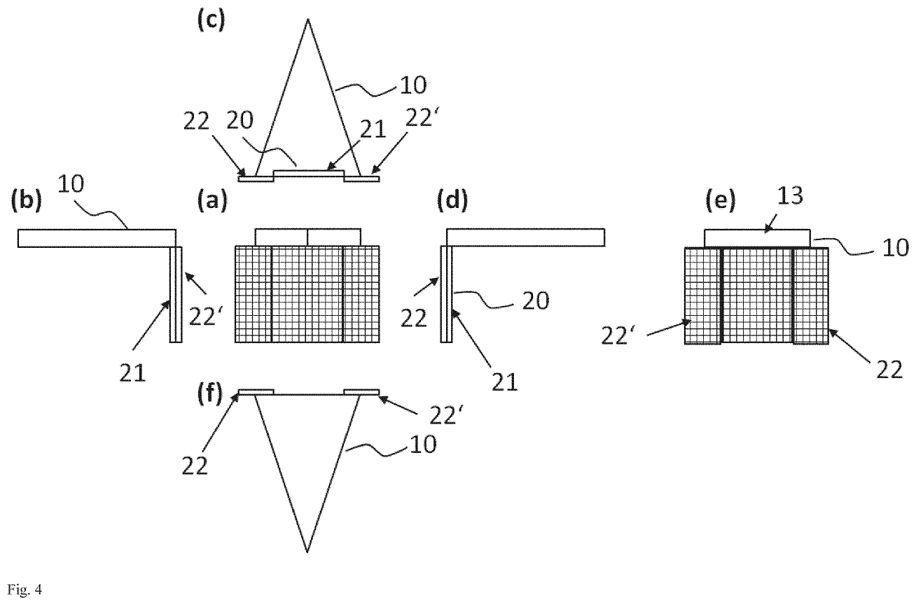

FIG. 4 shows schematically the crop divider (10) with the contact electrode (20) from FIG. 3. The side parts (22, 22′) are outwardly foldable; in FIG. 4, they are folded out to the sides, and so a larger electrode area is formed.

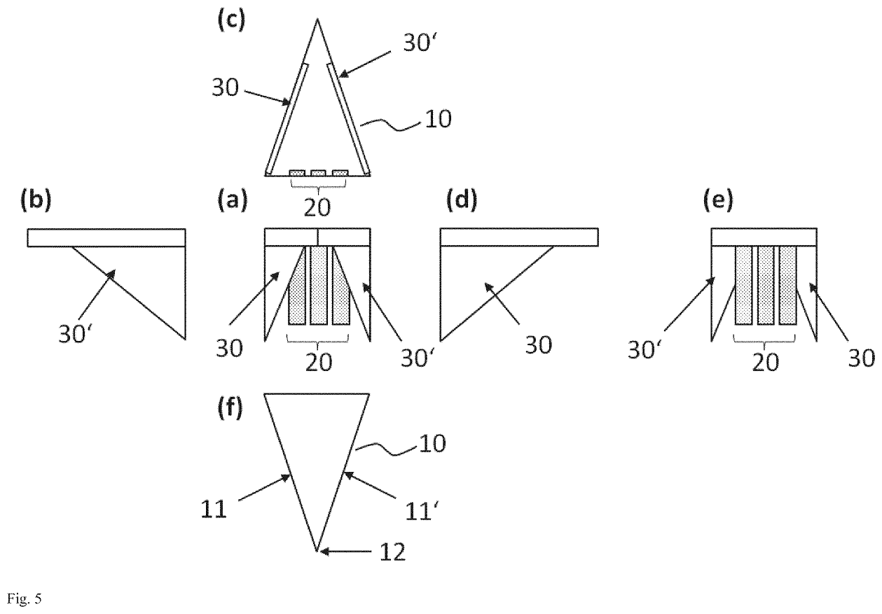

FIG. 5 shows schematically the crop divider (10) with the contact electrode (20) from FIG. 2. Guiding flanks (30, 30′) are attached to the lateral sides (11, 11′) of the crop divider (10). Between the guiding flanks, it is possible to provide a light barrier which registers whether a plant is situated between the flanks.

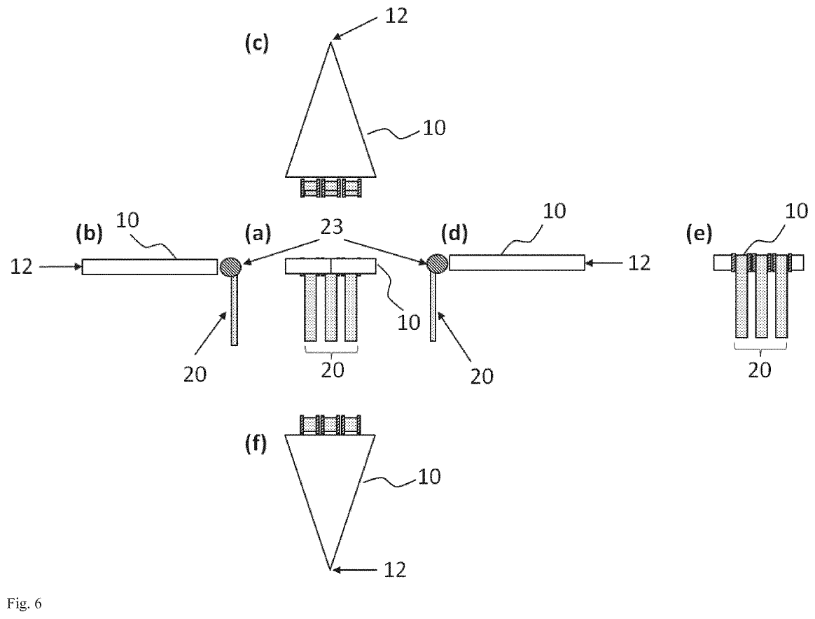

FIG. 6 shows schematically (a) a frontal view, (b) a first side view, (c) the underside, (d) a second side view, (e) a rear view and (f) a top view of the crop divider (10) from FIG. 1 together with a contact electrode.

The contact electrode (20) comprises three metal strips which are each rolled onto a reel (23). The length of the contact electrode can be reduced by winding the metal strips onto the reels; the length of the contact electrode can be increased by unwinding the metal strips from the reels.

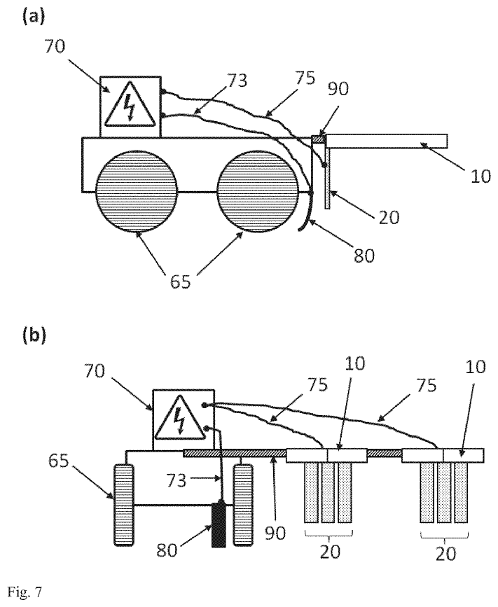

FIG. 7 shows schematically (a) a side view and (b) a frontal view of a vehicle according to the invention.

According to some embodiments, the vehicle according to the invention moves through the field on wheels (65). Mounted in the front region of the vehicle is a cantilever (90) to which two crop dividers (10) and two contact electrodes (20) are attached. These are the crop dividers (10) and contact electrodes (20) from FIG. 2. The crop dividers (10) and contact electrodes (20) are arranged spaced apart from one another and next to one another, and extend transversely (at an angle of 90° in the present case) to the direction of movement and perpendicularly to gravity.

The vehicle comprises a voltage source (70). The contact electrodes (20) are connected to the voltage source (70) via cables (75). The vehicle comprises a counter electrode (80) which is in contact with the ground as a sliding electrode. The counter electrode is likewise connected to the voltage source (70) via cables (73). It is conceivable that the cantilever (90) is height-adjustable, so that the crop dividers (10) can be brought to a height which is above the growth height of the cultivated-plant cohabitants and below the growth height of the cultivated plants. The contact electrodes are then situated below the crop divider at the growth height of the cultivated-plant cohabitants.

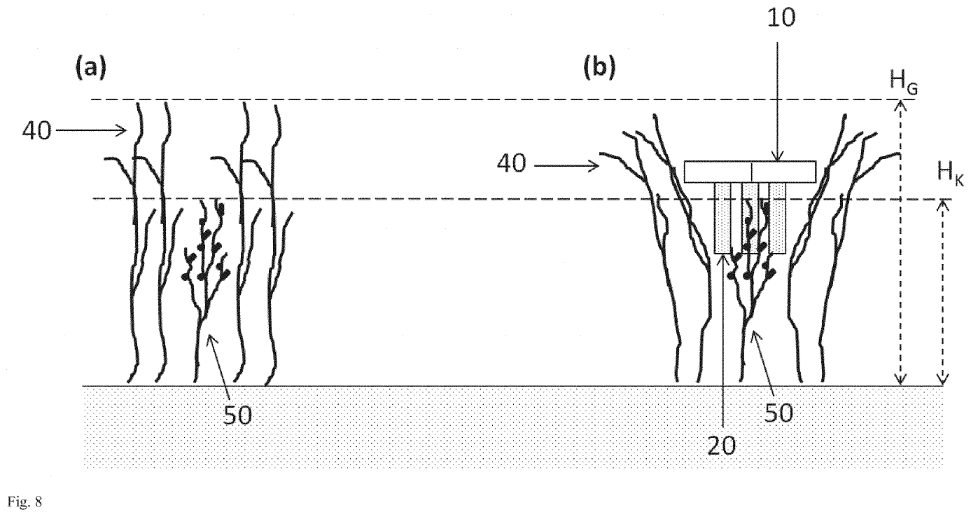

FIG. 8 shows schematically the use of a crop divider (10) together with a contact electrode (20) in controlling a cultivated-plant cohabitant (50) in a population of cultivated plants (40). The crop divider (10) and the contact electrode (20) are those from FIG. 2. In FIG. 8(a), it can be seen that the cultivated-plant cohabitant (50) has a growth height of H_{K}, which is lower than the growth height of the surrounding cultivated plants H_{G}.

In FIG. 8(b), it can be seen that the crop divider (10) is brought to a height which is lower than the growth height H_{G} of the cultivated plants, but is greater than the growth height H_{K} of the cultivated-plant cohabitant. The contact electrode (20) is situated below the crop divider (10) at the level of the growth height of the cultivated-plant cohabitant.

In FIG. 8(b), it can be seen that the crop divider together with the contact electrode (20) is moving forward out of the picture and, in doing so, is guiding the cultivated plants (40) to the side and past the contact electrode (20). The cultivated-plant cohabitant (50) having the lower growth height H_{K} is not swept away by the crop divider (10). It comes into contact with the contact electrode (20).

1. A method for controlling cultivated-plant cohabitants in a field of cultivated plants, comprising:
providing a device comprising a crop divider and a contact electrode,
bringing the crop divider to a height which is above a growth height of the cultivated-plant cohabitants and below a growth height of the cultivated plants,
bringing the contact electrode to a height which is below the crop divider at the growth height of the cultivated-plant cohabitants,
moving the device through a field for cultivated plants, in which cultivated-plant cohabitants appear,
during the movement
guiding the cultivated plants past the contact electrode via the crop divider,
contacting the cultivated-plant cohabitants with the contact electrode, wherein contact of the contact electrode with a cultivated-plant cohabitant leads to flow of a current from the contact electrode through part of the cultivated-plant cohabitant to a counter electrode, whereupon the cultivated-plant cohabitant is weakened or destroyed.

2. The method of claim 1, wherein a voltage prevails between the contact electrode and the counter electrode only when a cultivated-plant cohabitant nears the contact electrode.

3. The method of claim 1,
wherein relatively large cultivated-plant cohabitants having a greater growth height than the cultivated plants and relatively small cultivated plants having a lower growth height than the cultivated plants are present in the field,
wherein, in a first step, the crop divider is brought to a height which is above the growth height of the relatively large cultivated-plant cohabitants, the contact electrode is brought to a height which is below the crop divider at the growth height of the relatively large cultivated-plant cohabitants and above the height of the cultivated plants, the crop divider together with the contact electrode is moved through the field and the contact electrode comes into contact with the relatively large cultivated-plant cohabitants in the process and they are weakened or destroyed as a result,
wherein, in a second step following the first step, the crop divider is brought to a height which is below the growth height of the cultivated plants and above the growth height of the relatively small cultivated-plant cohabitants, the contact electrode is brought to a height which is below the crop divider at the growth height of the relatively small cultivated-plant cohabitants, the crop divider together with the contact electrode is moved through the field and the contact electrode comes into contact with the relatively small cultivated-plant cohabitants in the process and they are weakened or destroyed as a result.

4. A device for controlling cultivated-plant cohabitants in a field of cultivated plants, comprising:
a crop divider comprising two lateral sides, wherein the lateral sides converge at a tip,
a contact electrode, wherein the contact electrode
is situated below the crop divider and
is situated on a side of the crop divider that is opposite the tip of the crop divider,
wherein the crop divider is configured for fastening to a vehicle at a height which is above a growth height of the cultivated-plant cohabitants and below a growth height of the cultivated plants.

5. The device of claim 4, further comprising a sensor for detecting a cultivated plant which is nearing the contact electrode during movement.

6. The device of claim 5, further comprising an actuator which applies a voltage between the contact electrode and a counter electrode once the sensor detects a cultivated-plant cohabitant which is nearing the contact electrode.

7. The device of claim 4, wherein the contact electrode is variable in its extent transversely to a direction of movement.

8. The device of claim 4, wherein the contact electrode has a central part and two side parts, wherein the side parts are configured to be folded out and protrude beyond the lateral sides of the crop divider when folded out.

9. The device of claim 4, wherein a length of the contact electrode is variable.

10. A vehicle for controlling cultivated-plant cohabitants in a field of cultivated plants, comprising:
a crop divider comprising two lateral sides, wherein the lateral sides converge at a tip,
a contact electrode,
a voltage source and
a counter electrode,
wherein the crop divider is adjustable in height and the contact electrode is situated below the crop divider and is situated on a side of the crop divider that is opposite the tip of the crop divider.

11. The vehicle of claim 10, further comprising a sensor unit for ascertaining a growth height of the cultivated plants and/or the cultivated-plant cohabitants.

12. The vehicle of claim 10, further comprising a height-adjustment unit for automatic height adjustment of the crop divider and/or the contact electrode.

13. The vehicle of claim 10, comprising the device according of claim 4.

14. The device of claim 4, wherein the device is configured to control plant cohabitants in a field of cultivated plants, wherein the cultivated-plant cohabitants have a lower growth height than the cultivated plants.

15. The vehicle of claim 10, wherein the vehicle is configured to control plant cohabitants in a field of cultivated plants, wherein the cultivated-plant cohabitants have a lower growth height than the cultivated plants.
